(19) United States
(12) Patent Application Publication
(10) Pub. No.: US 2025/0173721 A1
(43) Pub. Date: May 29, 2025

(54) ON-CHAIN ATTESTATIONS USING USER DATA

(71) Applicant: Coinbase, Inc., Oakland, CA (US)

(72) Inventors: Qi Wu, Orchard (SG); Rhea Kaw, Bellevue, WA (US); Niranjan Bhaskar Prithviraj, Atlanta, GA (US); Fu Yuen Lai, London (GB); David Neil Roth, San Francisco, CA (US); Shelley Lai, Brooklyn, NY (US)

(21) Appl. No.: 18/521,908

(22) Filed: Nov. 28, 2023

(51) Int. Cl. G06Q 20/40; G06Q 20/02; G06Q 20/38

(52) U.S. Cl. CPC G06Q 20/4014; G06Q 20/02; G06Q 20/3825; G06Q 20/407

(57) ABSTRACT

Methods, systems, and devices for data management are described. A custodial token platform may receive a request, from a client application on a user device, to generate an attestation record associated with a user profile of the custodial token platform. The custodial token platform may verify, after receiving the request, that the user profile is associated with the set of attributes for the requested attestation record. The custodial token platform may broadcast, after verifying that the user profile is associated with the set of attributes, a first message configured to generate the attestation record via a blockchain network, where the first message is signed using a key associated with the custodial token platform. The custodial token platform may broadcast a second message configured to store a mapping of an identifier for the attestation record and a self-custody blockchain address associated with the user profile.

### FIELD OF TECHNOLOGY

The present disclosure relates generally to data management, including techniques for on-chain attestations using user data.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 show examples of computing environments that support on-chain attestations using user data in accordance with aspects of the present disclosure.

FIGS. 3 and 4 show examples of user interface flows that support on-chain attestations using user data in accordance with aspects of the present disclosure.

FIGS. 5 and 6 show examples of process flows that support on-chain attestations using user data in accordance with aspects of the present disclosure.

FIG. 7 shows a block diagram of an apparatus that supports on-chain attestations using user data in accordance with aspects of the present disclosure.

FIG. 8 shows a block diagram of a attestation service that supports on-chain attestations using user data in accordance with aspects of the present disclosure.

FIG. 9 shows a diagram of a system including a device that supports on-chain attestations using user data in accordance with aspects of the present disclosure.

FIGS. 10 and 11 show flowcharts illustrating methods that support on-chain attestations using user data in accordance with aspects of the present disclosure.

### DETAILED DESCRIPTION

An attestation may be evidence or proof of a statement. In the context of a blockchain environment (e.g., Web3), attestations may involve digital signatures, cryptographic proofs, or the like which serve as the evidence or proof of the statement. Attestations may facilitate proof of identity, ownership, or any attribute associated with a user or entity, such as a user profile of a platform of the blockchain environment. In some examples, users in the blockchain environment may leverage records of attestations in order to establish trust between users, between users and entities, users and services, or the like. For example, a first user entering an agreement or otherwise communicating with a second user may prove one or more credentials relevant to the agreement or communication via the attestation. Additionally, or alternatively, entities of the blockchain environment, such as custodial token platforms, decentralized apps (Dapps), third-party services, or the like may restrict access to and/or distribute rewards (e.g., yield, airdrops) on the platform, app, service, or the like according to users having one or more credentials. In order to obtain access to or receive rewards on the platforms, Dapps, services, or the like without revealing private information, users may leverage attestations serving as evidence of having the one or more credentials.

In some cases, soulbound tokens may represent attestations associated with a user. Soulbound tokens may be non-transferrable, non-fungible tokens (NFTs). That is, soulbound tokens may not be exchanged, transferred, sold, or otherwise given to a different user after being issued (e.g., being minted). In other words, soulbound tokens are “bound” to the user they are issued to. Soulbound tokens may be issued to users based on credentials associated with the user. For example, a platform may issue a soulbound token for a user after receiving one or more credentials (e.g., or proof of one or more credentials). In other words, the platform may issue the soulbound token for the user after the user satisfies and/or completes know-your-customer (KYC) requirements. However, soulbound tokens may not be able to represent different attestation types and may not be revoked once issued. In other words, soulbound tokens may not be as flexible as attestations.

As described herein, a custodial token platform may receive requests for and facilitate generation of attestations for users. For example, the custodial token platform may receive a request to generate an attestation for a user. The custodial token platform may access, based on receiving the request, user records to determine whether the user is eligible for the attestation. For example, the user may request that the custodial token platform attest that a balance of the user account (e.g., a balance of a crypto token) is above a threshold. The custodial token platform may access the user record to confirm or deny whether the balance is above the threshold and proceed with generating the attestation.

To generate the attestation, the custodial token platform may broadcast one or more messages. That is, the custodial token platform may broadcast a message to generate the attestation and another message to store a record of the attestation. The custodial token platform may generate the attestation for the user via one or more self-executing programs on a blockchain network, such as a smart contract associated with an attestation service (e.g., Ethereum Attestation Service (EAS)). For example, the one or more self-executing programs may generate an on-chain attestation associated with the wallet of the user account, as well as generate a record where the attestation is associated with a wallet address of the user.

On-chain attestations may be associated with benefits as opposed to, for example, soulbound tokens. For example, on-chain attestations may support establishment of a decentralized identity (DID) for users, where identities of users may be authenticated in a decentralized manner (e.g., without a centralized entity). On-chain attestations may, generally, represent a more decentralized attestation method and may be associated with a broader range of use-cases (e.g., support different attestation types) as opposed to soulbound tokens. Additionally, on-chain attestations may be standardized in a manner such as to be supported by many different parties participating in blockchain networks, such as Dapp providers, centralized or decentralized exchanges, Web3 services, smart contracts, users, and the like.

Aspects of the disclosure are described herein with respect to issuing attestations for user profiles and/or to user wallets. However, it should be understood that attestations may be issued for other types of entities, such as organizations, companies, groups, teams, services, smart contracts, etc. In such cases, information may be gathered or obtained for the entity and used to determine attestation eligibility. Attestations may be generated for wallet addresses associated with such entities.

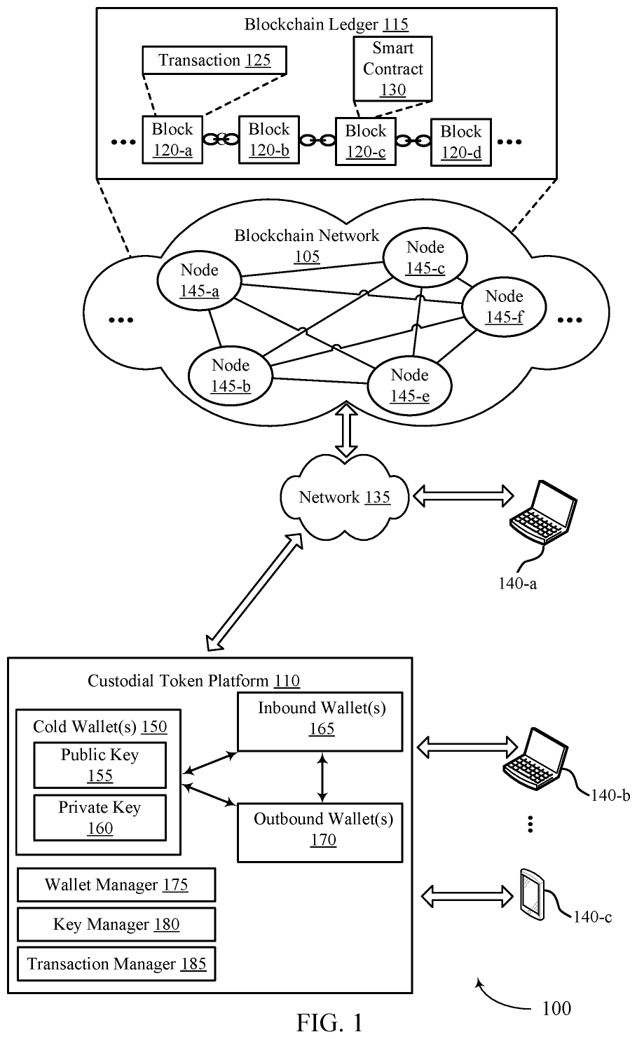

FIG. 1 illustrates an example of a computing environment 100 that supports on-chain attestations using user data in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital asset between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

As described herein, the custodial token platform 110 may facilitate generation of on-chain attestations for user accounts of the custodial token platform 110. For example, the custodial token platform 110 may receive a request to generate an attestation from a client application on a computing device, such as the computing device 140-b or the computing device 140-c. The attestation may be associated with a user profile of the custodial token platform 110. For example, once generated, the attestation may be associated with a wallet (e.g., a self-custody wallet) associated with the user profile, and a record of an association between the attestation and the wallet may be stored on-chain.

The custodial token platform 110 may generate the on-chain attestations by broadcasting one or more messages. For example, the custodial token platform 110 may broadcast a first message to generate the attestation and a second message to store the association between the attestation and the wallet. That is, the custodial token platform 110 may generate the attestation and the record of the association via the blockchain network 105. In some cases, the custodial token platform 110 may use various types of keys to support attestations, such as keys accessible via the key manager 180. For example, the custodial token platform may access a first set of hot keys that are used to sign and issue (e.g., broadcast) attestations and a second set of hot keys that are used to manage smart contracts (e.g., keys that support administrative functions of smart contracts, such as upgrades).

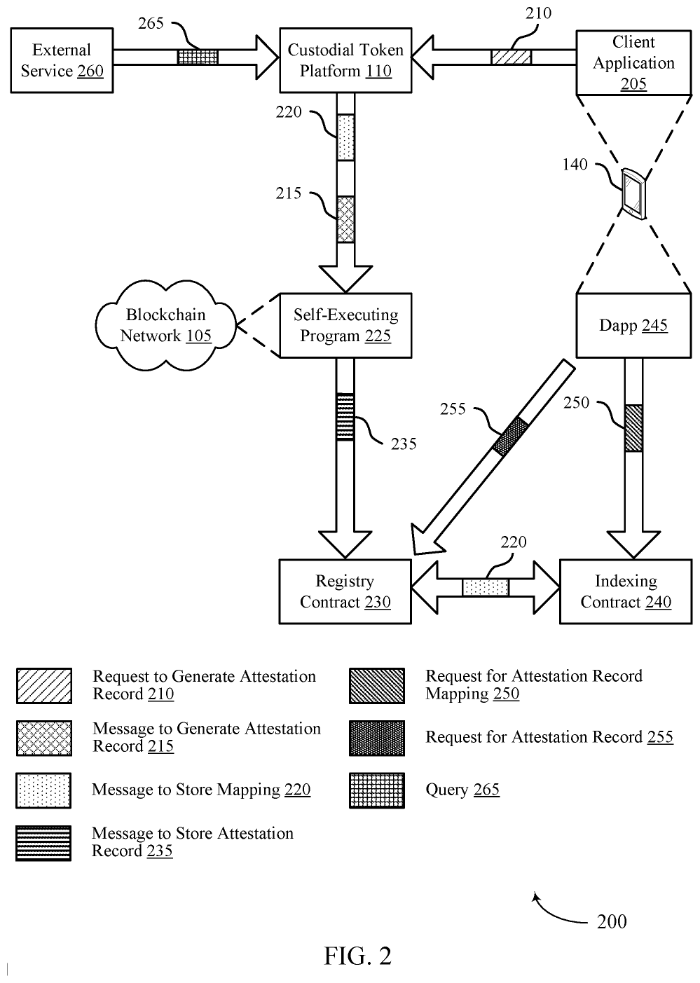

FIG. 2 shows an example of a computing environment 200 that supports on-chain attestations using user data in accordance with aspects of the present disclosure. The computing environment may include a computing device 140, a custodial token platform 110, and a blockchain network 105 which may be examples of corresponding devices as described with reference to FIG. 1. The computing environment 200 may also include a client application 205, which may be associated with the custodial token platform 110 as described with reference to FIG. 1.

The custodial token platform 110 may facilitate the generation of on-chain attestations for a user profile. For example, the custodial token platform 110 may receive a request to generate an attestation record 210 from the client application 205 on the computing device 140. In other words, a user may request that the custodial token platform 110 generate an attestation on their behalf. The request to generate the attestation record 210 may be received from, and associated with, the user profile of the custodial token platform 110. For example, the request to generate the attestation record 210 may include an indication of a wallet address associated with (or that is to be associated with) the user profile.

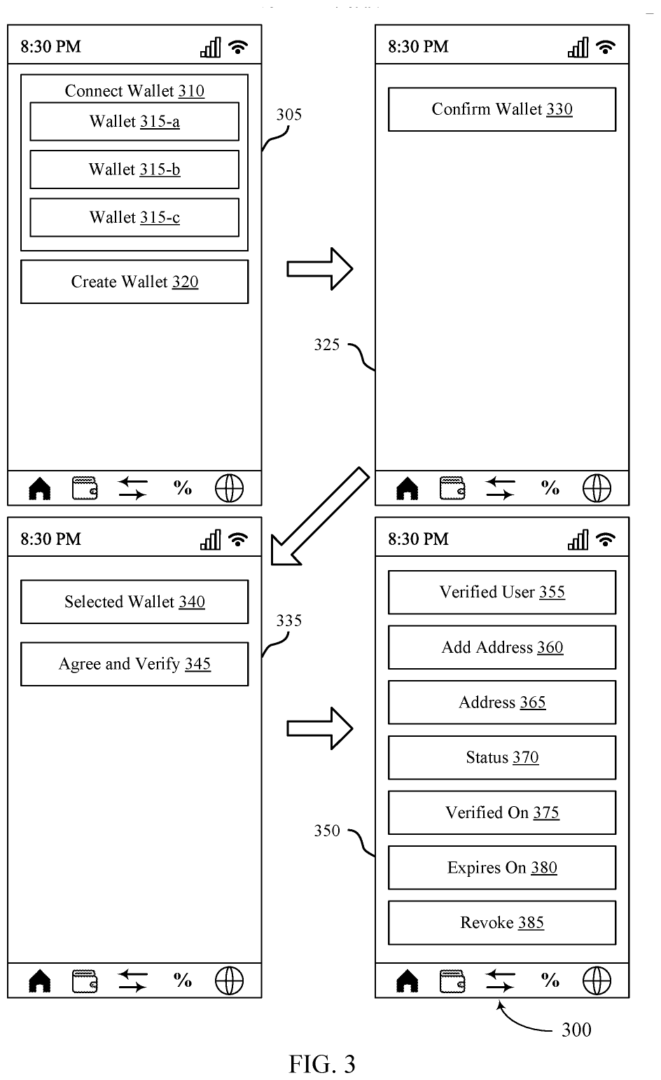

In some examples, the custodial token platform 110 may facilitate the generation of the on-chain attestations for the user profile based on the user profile verifying a wallet address and/or signing a user agreement. That is, before a user may request attestations from the custodial token platform 110, the user may prove that they are the owner of a wallet by sending a message signed via the wallet address. The wallet verification may be described in further detail elsewhere, including with reference to FIG. 3.

The custodial token platform 110 may retrieve stored information associated with the user profile to determine whether the user meets one or more criteria for the attestation. For example, the custodial token platform 110 may include an eligibility service which evaluates whether the user is eligible for the requested attestation. That is, the custodial token platform 110 (e.g., or the eligibility service of the custodial token platform) may determine whether the user meets the criteria for the attestation and move forward with generating the attestation record via the blockchain network 105 accordingly. For example, the custodial token platform 110 may determine that the user profile does not meet the one or more criteria for the attestation, and the custodial token platform 110 may indicate to the user who requested the attestation record via the client application 205 that the user profile is ineligible for the attestation.

Or, the custodial token platform 110 may determine that the user satisfies the one or more criteria for the attestation. For example, the custodial token platform 110 may broadcast (e.g., transmit via the blockchain network 105) one or more messages to generate the attestation record and store a mapping of the record. That is, the custodial token platform 110 may broadcast a message to generate the attestation record 215 and a message to store a mapping 220.

The message to generate the attestation record 210, the message to store the mapping 220, or both may be configured to call a self-executing program 225 (or multiple self-executed programs) associated with the blockchain network. The self-executing program 225 may correspond to a set of smart contracts that may be used for managing attestations about any entity, such as the user profile, via asymmetric cryptography. Asymmetric cryptography may involve use of a key pair (e.g., a public key and a private key) for encryption and/or decryption, signing messages, or the like. In the example of on-chain attestations, the self-executing program 225 may use asymmetric cryptography to perform transactions on-chain and/or generate attestations about an entity, such as the user profile.

The self-executing program 225 may manage attestations for users of the custodial token platform 110. For example, the self-executing program 225 may issue, revoke, and/or expire attestations based on communications with the custodial token platform 110, an attestation service, or the like. In some examples, the self-executing program 225 may store the attestations via a registry contract 230. For example, the self-executing program 225 may send a message to store the attestation record 235 to the registry contract 230 such that the attestation record is stored on-chain. The registry contract 230 may be an example of and/or be associated with EAS. In other words, the self-executing program 225 may leverage EAS to store attestations on-chain.

Additionally, or alternatively, the self-executing program 225, via the registry contract 230, may store a record of the mapping in an indexing contract 240. For example, each attestation may be associated with a user address, and the indexing contract 240 may store a record of each association. The indexing contract 240 may be an example of a data contract which stores a mapping of an attester, a recipient, a schema, and/or an attestation identifier. In some examples, the indexing contract 240 may verify the attestation in the registry contract 230 (e.g., ensure that the attestation exists) before indexing the mapping. The indexing contract 240 may include manually indexed attestations (e.g., backfilled attestations).

In some examples, the registry contract 230 and the indexing contract 240 may be connected via a schema resolver. For example, the schema resolver may be triggered by the registry contract 230 when an attestation is associated with a schema. In other words, the schema resolver may initiate and/or automate indexing in the indexing contract 240 after an attestation is entered in the registry contract 230.

In some examples, a Dapp 245 may access the indexing contract 240 to verify whether an attestation exists for a user. For example, the computing device 140 may access the Dapp 245 where, in order to be eligible to access the Dapp 245, the Dapp 245 may require that a user have a certain attestation. The Dapp 245 may send a request for attestation record mapping 250 to the indexing contract 240 in order to determine whether the user is eligible to access features or services of the Dapp 245. Additionally, or alternatively, the Dapp 245 may retrieve the attestation from the registry contract 230 by sending a request for the attestation record 255.

The Dapp 245 may access the indexing contract 240 via a software development kit (SDK), helper contracts, or both. For example, the SDK may retrieve one or more attestations associated with the user profile from the indexing contract 240 for the Dapp 245. In other words, the Dapp 245 may query the indexing contract 240 via the SDK to retrieve associated attestations for an address (e.g., a wallet address) associated with the user or the user profile. The SDK may forward one or more attestations (e.g., relevant attestations) to the Dapp 245 or directly to a smart contract associated with the Dapp 245 such that the Dapp 245 may identify that the user is associated with attestations required to interact with (e.g., gain access to) the smart contract. In some examples, the Dapp 245 may leverage the indexing contract 240 to identify whether the user is associated with attestations required for one or more benefits supported by the Dapp 245, such as rewards (e.g., yields or airdrops) or services. Additionally, or alternatively, in some examples, the Dapp 245 may leverage the indexing contract 240 to identify whether the user profile is associated with a human user (e.g., as opposed to a bot).

Additionally, or alternatively, the Dapp 245 may use the helper contracts to check a validity of the retrieved attestations. For example, a helper contract may determine whether an attestation is valid based on an attestation identifier, a schema identifier, and an expected recipient and/or subject address. That is, the helper contract may identify whether the schema identifier and recipient address match. The helper contract may also determine a status of the attestation. For example, the helper contract may determine that the attestation is invalid if it does not exist, is expired, or has been revoked. Additionally, or alternatively, the Dapp 245 may check the validity of the retrieved attestations via the custodial token platform 110. For example, the Dapp 245 may request a copy (e.g., a reproduction of) a validation or verification logic of the retrieved attestations from the custodial token platform 110.

In some aspects, an external service 260 may send a query 265 the custodial token platform 110. For example, the external service 260 may send the query 265 to determine whether a user account is associated with a criteria and/or has one or more attestation records. In other words, the external service 260 may query the custodial token platform 110 for information about a user account. In some examples, the custodial token platform 110 may respond to the query 265 indicating whether the criteria is satisfied and/or the attestation records exist without revealing information, such as personally identifiable information (PII), about the user. For example, the custodial token platform 110 may access the self-executing program 225 to determine the status of an attestation (e.g., whether an attestation has been revoked, expired, etc.) and respond to the query 265. Additionally, or alternatively, the custodial token platform 110 may leverage attestations issued by external services (e.g., third parties) to respond to the query. In other words, the custodial token platform 110 may access attestation records associated with a wallet address of a user account which were not issued by the custodial token platform 110 to respond to the query.

As an example, the external service 260 may query the custodial token platform 110 about an attribute of a user, such as a geographic location. The custodial token platform 110 may access the self-executing program 225 and respond to the query with an indication of whether the user is at the geographic location (e.g., “true” or “false”), an indication of an attribute of the user (e.g., a country code in the example of a geographic location), or if the custodial token platform 110 does not have the information to answer the query. For example, the external service 260 may query the custodial token platform 110 regarding the user's geographic location, and the custodial token platform 110 may return an attestation record that indicates the country (e.g., the attestation includes a country code for the user).

FIG. 3 shows an example of a user interface flow 300 that supports on-chain attestations using user data in accordance with aspects of the present disclosure. The user interface flow 300 may be implemented by a client application of a custodial token platform on a user device. For example, the user interface flow 300 may be implemented by the client application 205 on the computing device 140 as described with reference to FIG. 2.

A user interface may display multiple content items to support on-chain attestations as described herein. The user interface flow 300 includes an example of the user interface where the multiple content items may be displayed to enable a user to request an on-chain attestation from a custodial token platform, such as the custodial token platform 110 as described with reference to FIG. 1 and FIG. 2.

For example, a first set of content items 305 of the user interface flow 300 may prompt the user to connect a wallet 310 from a list of wallets 315 (e.g., self-custody wallet applications), including a wallet 315-a, a wallet 315-b, and a wallet 315-c. The first user interface may also provide an option to create a wallet 320 (e.g., regardless of whether the user account already has one or more wallets), such as a self-custody wallet supported by the application. The first set of content items 305 may display the option to connect the wallet 310 to support the generation of the on-chain attestation, where the selected wallet will be used to associated the on-chain attestation with a wallet address. That is, the user may select which wallet may be associated with the attestation to be generated.

The user interface may display a second set of content items 325 based on receiving an input indicating a selected wallet (or selected wallet application). The second set of content items 325 may display an option to confirm the wallet 330. In other words, the user may confirm the selection made via the first set of content items by signing into the selected wallet. For example, a user may verify that they are the owner of the selected wallet by signing a message with the wallet address. Additionally, or alternatively, the user may return to the first set of content items 305 and make a new selection or otherwise exit the user interface flow 300.

In some examples, the user interface may display, in the second set of content items 325 or in a different set of content items, an option to select an attestation type. For example, the user may select one or more attestations to be generated by the custodial token platform. The user interface may display attestations for which the user is eligible. In other words, the user interface may determine which attestations of a set of attestations are able to be generated by the custodial token platform for which the user profile is eligible. The user may then select some or all of the eligible attestations.

The user interface may display a third set of content items 335 based on receiving the input confirming the selected wallet. For example, the third set of content items 335 may include an indication of the selected wallet 340, an option to agree and verify 345, and, in some examples, an indication of the one or more attestations selected by the user. That is, the user may agree to a set of terms associated with the custodial token platform generating the on-chain attestation on behalf of the user. For example, based on the set of terms, the custodial token platform may revoke and/or expire an attestation associated with the selected wallet 340 of the user account.

Additionally, or alternatively, selecting the option to agree and verify 345 may trigger the custodial token platform to verify that the user is associated with one or more criteria for the requested attestation. For example, the custodial token platform may access a user database having information about the user account to determine whether the user is eligible for the attestation. Or, in some other examples, the custodial token platform may query another internal or external database (e.g., not associated with the custodial token platform) to verify whether the user is associated with the one or more criteria. That is, the custodial token platform may access public records and/or publicly available data sources (e.g., outside of the user database and/or the user profile). Example external sources may include a United Nations (UN) sanctions list, a United States (US) sanctions list, public social media information (e.g., Tweets, Reddit posts), credit information (from credit rating providers), property records, etc.

After verifying that the user is associated with the one or more criteria, the custodial token platform may call a schema of a registry contract, such as the registry contract 230 as described with reference to FIG. 2. For example, the custodial token platform may call the schema, where the call includes information to fill in one or more fields of the schema. The information may include one or more identifiers for the custodial token platform (e.g., a source, an intended receiver (receiver address), etc.), an identifier for the attestation record (e.g., a Uid), or both.

The registry contract may generate and manage the attestation record, and an indexing contract, such as the indexing contract 240 as described with reference to FIG. 2, may store a mapping between the attestation record and the wallet address. That is, the indexing contract may broadcast an association between the attestation record and the wallet address on-chain.

The user interface may display a fourth set of content items 350 based on receiving the input that the user agreed and verified the on-chain attestation request. In other words, the user interface flow 300 may display the fourth set of content items 350 based on the attestation record being broadcasted on chain (e.g., by the registry contract) and/or the mapping between the attestation record and the wallet address being broadcasted on-chain (e.g., by the indexing contract).

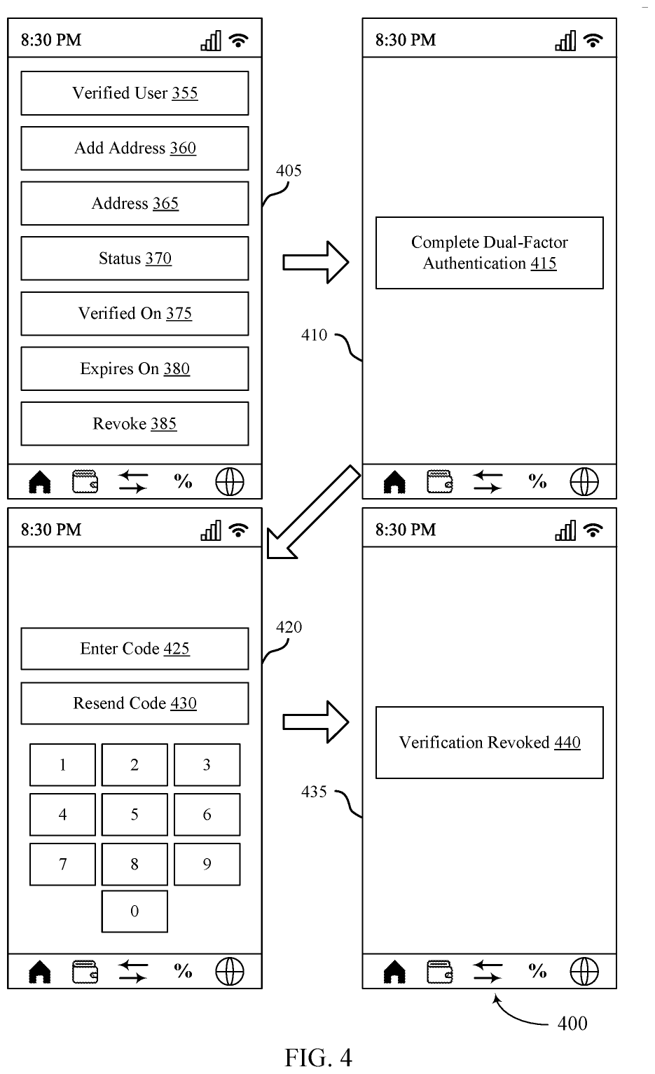

The fourth set of content items 350 may include an indication that the user is verified 355 (e.g., that the user has the attestation record), an option to add an address 360, an indication of an address 365 associated with the attestation record, a status 370 of the attestation record, an indication of a date the user was verified on 375 (e.g., a date the attestation was broadcasted on-chain), an indication of a date that the attestation record expires on 380, and an option to revoke 385 the attestation record. The option to revoke may be explained in further detail elsewhere, including with reference to FIG. 4.

In some examples, the user may select the option to add the address 360. For example, the user may request to generate an additional attestation record associated with a wallet address that the attestation has not already been generated for (e.g., the wallet address 365). The user interface may display the first set of content items 305 based on receiving an input selecting the option to add the address 360.

FIG. 4 shows an example of a user interface flow 400 that supports on-chain attestations using user data in accordance with aspects of the present disclosure. The user interface flow 400 may be implemented by a client application of a custodial token platform on a user device. For example, the user interface flow 400 may be implemented by the client application 205 on the computing device 140 as described with reference to FIG. 2.

Alternative examples of the following may be implemented, where some sets of content items are displayed in a different order than described or are not displayed at all. In some cases, sets of content items may include additional content items not mentioned below, or further content items may be added.

A user interface may display multiple content items to support revocation of on-chain attestations as described herein. The user interface flow 400 includes an example of the user interface where the multiple content items may be displayed to enable a user to request an on-chain attestation be revoked via a custodial token platform, such as the custodial token platform 110 as described with reference to FIG. 1 and FIG. 2.

The user interface may display a first set of content items 405 based on a user account having an attestation record generated via the custodial token platform. For example, the first set of content items may include an indication that the user is verified 355, an option to add an address 360, an indication of an address 365 associated with the attestation record, a status 370 of the attestation record, an indication of a date the user was verified on 375, an indication of a date that the attestation record expires on 380, and an option to revoke 385 the attestation record.

As an example, the user may select the option to revoke 385 the attestation record. The user interface may display a second set of content items 410 based on receiving an input selecting the option to revoke 385 the attestation record. For example, the second set of content items 410 may display an indication that the user is to complete dual-factor authentication 415. The user may select to complete the dual-factor authentication 415 or exit the user interface flow 400 (e.g., and forego revoking the attestation record).

The user interface may display a third set of content items 420 based on receiving an input to complete the dual-factor authentication 415. For example, the third set of content items 420 may include an indication that the user is to enter a code 425, an option to resend the code 430, and a ten-digit keypad allowing a user to enter the received code. In other words, the client application may trigger the custodial token platform to revoke the attestation after verifying an identity of the user via the dual-factor authentication.

The user interface, after receiving an input of the code to complete the dual-authentication, may revoke the attestation. For example, the custodial token platform may revoke the schema via a self-executing program, such as the self-executing program 225 as described with reference to FIG. 2. The self-executing program may call a contract to revoke the attestation. For example, the self-executing program may revoke the attestation by requesting that one or more nodes (e.g., attesters) sign the contract to revoke the attestation. The self-executing program may also call an indexing contract, such as the indexing contract 240 as described with reference to FIG. 2, to broadcast an updated index for the revoked attestation on-chain. That is, the revocation of the attestation may not remove the attestation from the indexing contract, but rather, update an entry to denote the attestation record as having been revoked.

The user interface display a fourth set of content items 435 after revoking the attestation. For example, the fourth set of content items 435 may include an indication that the verification is revoked 440. In some aspects, the fourth set of content items 435 may include an option to re-issue the verification. That is, the user may select to re-issue the revoked attestation. The user interface may, based on receiving an input to re-issue the attestation, return to the user interface flow 300 as described with reference to FIG. 3.

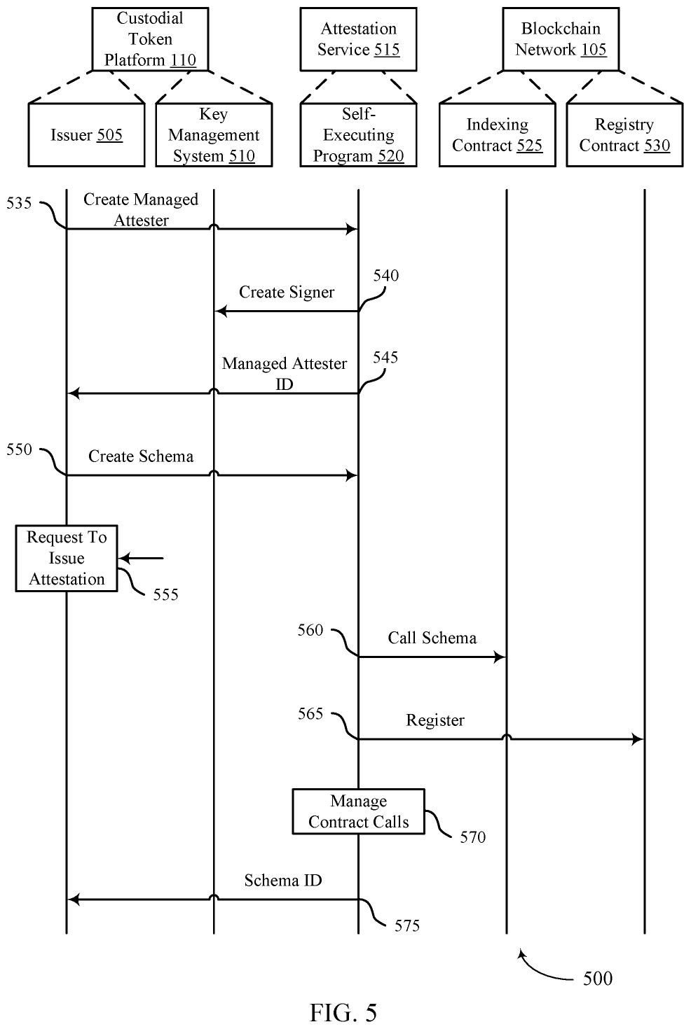

FIG. 5 shows an example of a process flow 500 that supports on-chain attestations using user data in accordance with aspects of the present disclosure. In some examples, the process flow 500 may implement or be implemented by aspects of the computing environment 100, the computing environment 200, the user interface flow 300, the user interface flow 400 as described with reference to FIGS. 1-4. For example, the process flow 500 may include a blockchain network 105, a custodial token platform 110, a self-executing program 520, an indexing contract 525, and a registry contract 530 which may be examples of corresponding devices as described with reference to FIGS. 1 and 2.

Alternative examples of the following may be implemented, where some steps are performed in a different order than described or are not performed at all. In some cases, steps may include additional features not mentioned below, or further steps may be added. Although the custodial token platform 110, an attestation service 515, and the blockchain network 105 are shown performing the operations of the process flow 500, some aspects of some operations may also be performed by one or more other wireless devices.

The custodial token platform 110 may include multiple subsystems, such as an issuer 505 and a key management system 510. For example, the issuer 505 may manage requests received by the custodial token platform 110 to issue attestations to a selected wallet address and/or issue attestations on-chain via the self-executing program 520. The key management system 510 (e.g., “KMS”) may sign attestations. For example, the key management system 510 may facilitate a single party or multi-party computation (MPC) signature function in which multiple MPC nodes may sign the attestation. In other words, a threshold quantity of MPC nodes may sign the attestation via shares of a key distributed to the multiple MPC nodes.

The custodial token platform 110 may leverage an attestation service 515 to generate attestations on-chain. For example, the attestation service 515 may include a self-executing program 520 (e.g., smart contract) configured to generate on-chain attestations.

The blockchain network 105 may include the indexing contract 525 and/or the registry contract 530. For example, the indexing contract 525 and/or the registry contract 530 may represent respective indexes and registrations which are broadcasted on-chain. That is, one may access the indexing contract 525 and/or the registry contract 530 to view a record of indexes of attestations and/or attestation records, respectively.

The custodial token platform 110, in order to facilitate the generation of on-chain attestations, may first configure attesters. For example, at 535, the issuer 505 may send a message to the self-executing program 520 of the attestation service 515 to create a managed attester. For example, the custodial token platform 110 may generate the attestation via the managed attester, where the managed attester may be one of a pool of attesters. The message to create the managed attester may define an address of an attester enabled to attest to a given attestation. For example, the issuer 505 may define multiple attesters for multiple attestations. In some aspects, the managed attester may be one or more MPC nodes associated with the key management system 510 of the custodial token platform 110. Additionally, or alternatively, the managed attester may be a third party service that is leveraging the attestation service supported by the custodial token platform 110.

At 540, the self-executing program 520 may send a message to the key management system 510 to create a signer. For example, the self-executing program 520 may send a message to the one or more MPC nodes associated with the key management system 510 enabled to attest to the given attestation. That is, when the issuer 505 initiates generation of an attestation, the self-executing program 520 may request that the one or more MPC nodes denoted as “signers” sign the attestation record in order for the attestation record to be on-chain (e.g., in the indexing contract 525, the registry contract 530, or both). In some examples, one or more MPC nodes may represent a threshold quantity of MPC nodes required to execute an MPC signature function.

At 545, the self-executing program 520 may send a managed attester identifier to the issuer 505. For example, self-executing program 520 may indicate an identifier associated with the attester created at 540. In some examples, the issuer 505 may use the managed attester identifier to call a schema. For example, the managed attester identifier may be included as a field in the schema.

In some aspects, the custodial token platform 110 may create a schema to generate an attestation record. For example, the attestation record may be recorded in the registry contract 530 as well as the indexing contract 525, where the registry contract 530 includes the actual attestation record while the indexing contract 525 includes information associating the attestation record with a wallet address.

The indexing contract 525 may include multiple schemas. For example, the self-executing program 520, to record the association between the attestation record and the wallet address, may call a schema of the multiple schemas.

At 550, the issuer 505 may create a schema. For example, the issuer 505 may create the schema based on configuring the attester at 535, 540, and 545. For example, the schema creation may involve assigning an attester, providing fields which may be provided to the self-executing program 520 from the issuer 505 in order to generate the attestation record, identifying whether or not an attestation is revokable, configuring an expiration for the attestation, or the like. In some examples, the schema may define the purpose of the attestation. For example, the custodial token platform 110 may attest to a geographic location of a user account and create the schema to have one or more fields related to the geographic location. Additionally, or alternatively, a schema may include fields that indicate other statuses of the user, such as whether the user qualifies as an accredited inventor, whether the user has passed Know Your Customer (KYC) checks at the custodial token platform 110, or the like. In some examples, to create the schema, a user may access a UI associated with or supported by the attestation service 515 to configure or select the fields. After selecting the fields, the schema may be stored at the self-executing program 520 and/or the indexing contract 525. In some examples, a records of the schema may be registered at the registry contract 530.

The one or more fields of the schema may be of different types. For example, the schema may include Boolean fields, address fields, string fields, identifier fields (e.g., Uid fields), or the like. In other words, the schema may include multiple fields including a variety of information.

At 555, the issuer 505 may receive a request to issue an attestation. For example, the issuer 505 may receive the request via an input at a client application associated with the custodial token platform 110. For example, the request may be associated with the client application itself and/or a service external to the custodial token platform, such as a third party service or a Dapp.

At 560, the self-executing program 520 may call the schema of the indexing contract 525. For example, the self-executing program 520 may call the indexing contract 525 to generate a mapping of the attestation record. The call may include information for each of the fields of the schema. That is, the self-executing program 520 may fill the fields of the schema (e.g., store information in the fields of the schema) from the message creating the schema at 550. The mapping of the attestation record may include the fields of the schema. That is, the indexing contract 525 may include information about which attestation records are associated with different wallet addresses, schemas, issuers, or the like.

At 565, the self-executing program 520 may register the attestation at the registry contract 530. For example, the self-executing program 520 may broadcast the attestation record on-chain via the registry contract 530.

At 570, the self-executing program 520 may manage contract calls. For example, the self-executing program 520 may generally receive requests to generate attestation records and perform operations at 560 and 565.

At 575, the self-executing program 520 may transmit a message to the issuer 505 indicating a schema identifier. For example, the schema identifier may indicate to the issuer 505 that the attestation record is broadcast on-chain. The issuer 505 may relay the schema identifier to a user (e.g., a user having the wallet address associated with the attestation record), to third parties, to Dapps, or the like. For example, services external to the custodial token platform 110 may access the indexing contract 525 to determine whether a wallet address is associated with a given attestation.

Additionally, or alternatively, the services external to the custodial token platform 110 may leverage the attestation service 515 to issue attestations on behalf of users. For example, the services external to the custodial token platform 110 may use a schema created by the custodial token platform 110 and/or use the attesters created at 535 through 545. In some examples, the services external to the custodial token platform 110 and/or the attestation service 515 may provide off-chain data (e.g., from a database of an external service) in order to issue the attestations. In other words, the custodial token platform 110 and/or the attestation service 515 may issue attestations for users of external services.

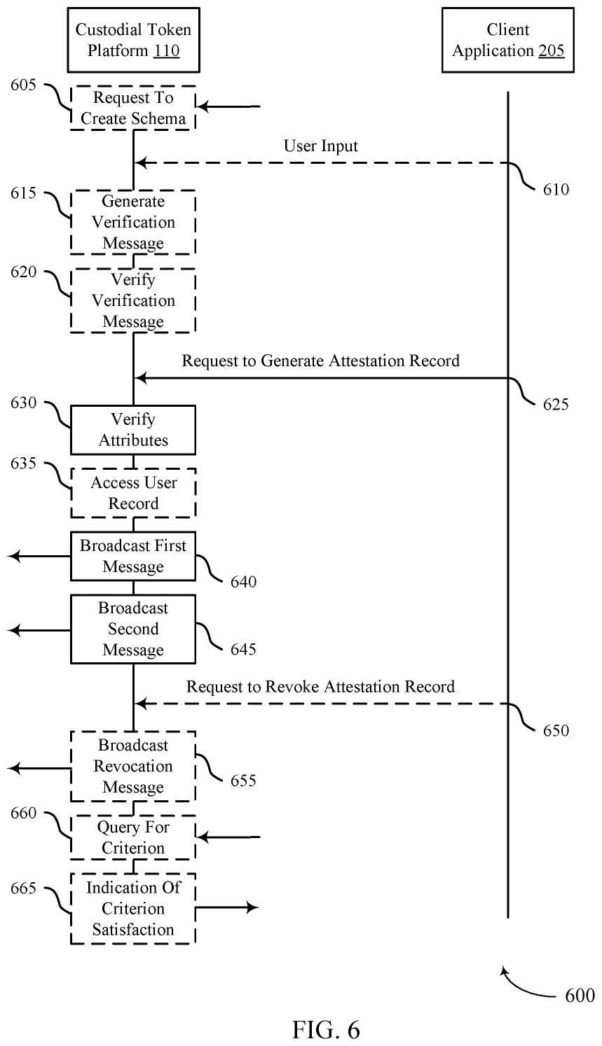

FIG. 6 shows an example of a process flow 600 that supports on-chain attestations using user data in accordance with aspects of the present disclosure. In some examples, the process flow 600 may implement or be implemented by aspects of the computing environment 100, the computing environment 200, the user interface flow 300, the user interface flow 400 as described with reference to FIGS. 1-4. For example, the process flow 600 may include a custodial token platform 110 and a client application 205 which may be examples of corresponding devices as described with reference to FIGS. 1 and 2.

Alternative examples of the following may be implemented, where some steps are performed in a different order than described or are not performed at all. In some cases, steps may include additional features not mentioned below, or further steps may be added. Although the custodial token platform 110, an attestation service 515, and the blockchain network 105 are shown performing the operations of the process flow 600, some aspects of some operations may also be performed by one or more other wireless devices.

The custodial token platform 110 may facilitate generation of on-chain attestation records in which attestation records are associated with wallet addresses via an indexing contract.

For example, at 605, the custodial token platform 110 may receive a request to create a schema. For example, the custodial token platform 110 may receive the request to create the schema from a service trusted by the custodial token platform 110, such as a third-party service or a Dapp. In other words, the trusted service may be associated with the client application 205. In some examples, the schema may be for an attestation record. For example, the trusted service may request that the custodial token platform 110 issue attestations for a user to perform one or more actions via the trusted service. That is, the trusted service may request that the custodial token platform 110 issue attestations on behalf of the user based on receiving a request from the user to perform the one or more actions requiring the attestations.

At 610, the custodial token platform 110 may receive a user input from the client application 205. The user input may indicate a self-custody blockchain address. That is, prior to generating attestation records for the user, the custodial token platform 110 may verify that the user is the owner of the self-custody blockchain address. In some examples, the user input indicating the self-custody blockchain address may be an example of associating an existing wallet of the user with the client application 205.

At 615, the custodial token platform 110 may generate a verification message. For example, the custodial token platform 110 may generate the verification message to determine whether the user is the owner of the self-custody blockchain address. That is, at 620, the custodial token platform 110 may verify the verification message which, if the user is the owner of the self-custody blockchain address, may be signed via a private key associated with the self-custody blockchain address.

At 625, the custodial token platform 110 may receive a request to generate an attestation record from the client application 205. The request may be associated with a user profile of the custodial token platform 110. For example, the request may be associated with the self-custody blockchain address previously verified by the custodial token platform.

In some examples, the custodial token platform 110 may verify that the request is received from a service trusted by the custodial token platform. For example, the custodial token platform 110 may receive the request via a Dapp associated with the client application 205, and/or a third party service. The custodial token platform 110 may establish that the service is trusted prior to issuing the attestation record.

At 630, the custodial token platform 110 may verify a set of attributes. For example, the custodial token platform 110 may check that the user profile is associated with the set of attributes for the attestation record requested at 625. In some examples, at 635, the custodial token platform 110 may access an off-chain database in order to determine whether the user is associated with the set of attributes. The off-chain database may include data associated with the user profile used to register the user on the custodial token platform 110, such as information verifying an identity of the user.

In other words, the custodial token platform 110 may access a user record managed by the custodial token platform 110 and associated with the user profile and determine whether the data of the user record satisfies one or more criteria indicated by the set of attributes. In some examples, the one or more criteria may be a token balance (e.g., of tokens associated with the user account and/or wallet address) and/or a geographic location. That is, the one or more criteria may be related to the requested attestation.

At 640, the custodial token platform 110 may broadcast a first message. For example, the first message may be configured to generate the attestation record via a blockchain network. The first message may be signed using a key associated with the custodial token platform 110, such as a key distributed to multiple MPC nodes.

In some examples, the first message may be configured to generate the attestation record via a self-executing program of the blockchain network. For example, the first message may be configured to call a schema for the attestation record stored in the self-executing program, where the first message includes the fields for the schema.

Additionally, or alternatively, the custodial token platform 110 may verify that the first message is received and finalized on the blockchain network and/or that the data to be stored is valid and matches the first message. That is, the custodial token platform 110 may check that the generated attestation record is correct before broadcasting a second message.

At 645, the custodial token platform 110 may broadcast the second message. For example, the second message may be configured to store a mapping of an identifier for the attestation record and a self-custody blockchain address associated with the user profile. The mapping may include an identifier for the custodial token platform 110 and/or a schema identifier for the attestation record. In other words, the second message may be configured to store the mapping in an indexing contract of the blockchain network.

At 650, the custodial token platform 110 may receive a request to revoke the attestation record from the client application 205. At 655, the custodial token platform 110 may broadcast a revocation message via the blockchain network to revoke the attestation record. Additionally, or alternatively the custodial token platform 110 may update a database (e.g., an internal record) to indicate that the attestation is revoked.

In some examples, the custodial token platform 110 may revoke the attestation record based on the user completing a dual-authentication procedure. That is, the custodial token platform 110 may verify that the request is received from an authorized user before revoking the attestation.

Additionally, or alternatively, the custodial token platform 110 may revoke the attestation based on a change to the set of attributes associated with the user profile. That is, the custodial token platform 110 may determine that the user profile is no longer associated with the set of attributes satisfying the one or more criteria (e.g., the attributes verified at 630) and, accordingly, revoke the attestation record. For example, the custodial token platform 110 may periodically (e.g., once a week) run a job (e.g., a background job) to determine whether the user profile is still eligible for the attestation. At 655, the custodial token platform 110 may revoke (e.g., proactively) the attestation if the user profile becomes ineligible. For example, the user profile may become ineligible for the attestation due to, for example, a reset for a KYC requirement or one or more sanctions making the user profile ineligible for trading. In such cases, the custodial token platform 110 may broadcast one or more messages to revoke the attestation. Additionally, or alternatively, the custodial token platform 110 may revoke and reissue a new attestation if the user profile becomes ineligible. For example, the user profile may become ineligible for a verified country attestation for a first country if the user moves to a second country. In such cases, the custodial token platform 110 may broadcast one or more messages to revoke the verified country attestation for the first country and one or more messages to issue a verified country attestation for the second country.

At 660, the custodial token platform 110 may receive a query for a criterion. For example, the query may be from a service external to the custodial token platform 110, such as a third party service and/or a Dapp. The custodial token platform 110 may access one or more contracts, such as the indexing contract having the mapping, in order to determine an answer to the query and transmit a response. Additionally, or alternatively, the custodial token platform 110 may access the user record (e.g., similarly to at 635) to determine whether the user satisfies the criterion. In some examples, the custodial token platform 110 may respond to the query at 665 with an indication of criterion satisfaction, such as an indication of “true” or “false.”

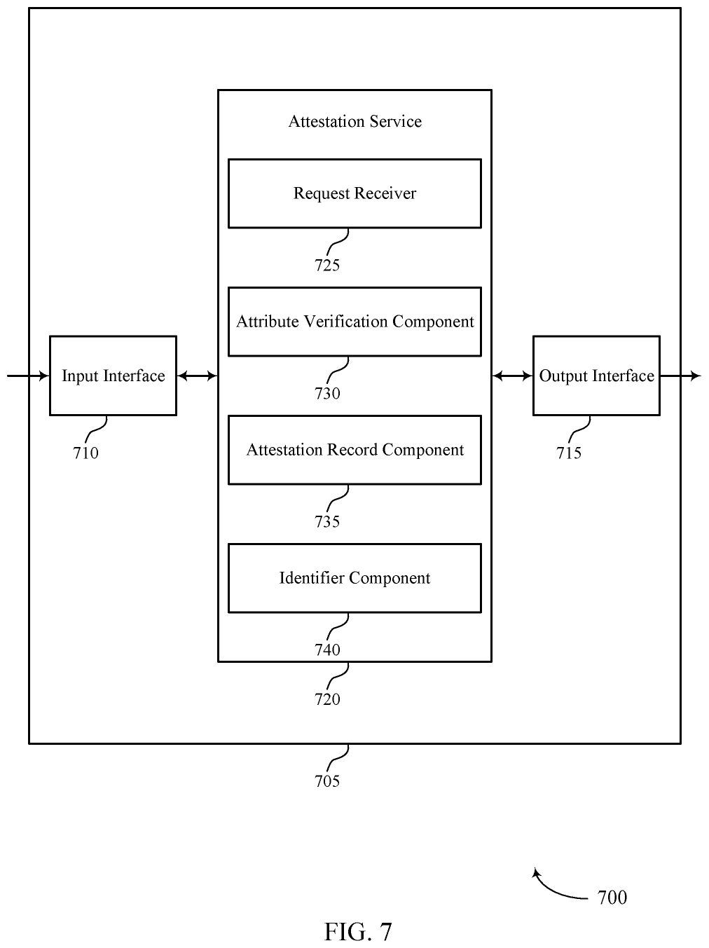

FIG. 7 shows a block diagram 700 of a system 705 that supports on-chain attestations using user data in accordance with aspects of the present disclosure. The system 705 may include an input interface 710, an output interface 715, and a attestation service 720. The system 705, or one or more components of the system 705 (e.g., the input interface 710, the output interface 715, and the attestation service 720), may include at least one processor, which may be coupled with at least one memory, to support the described techniques. Each of these components may communicate, directly or indirectly, with one another (e.g., via one or more buses, communications links, communications interfaces, or any combination thereof).

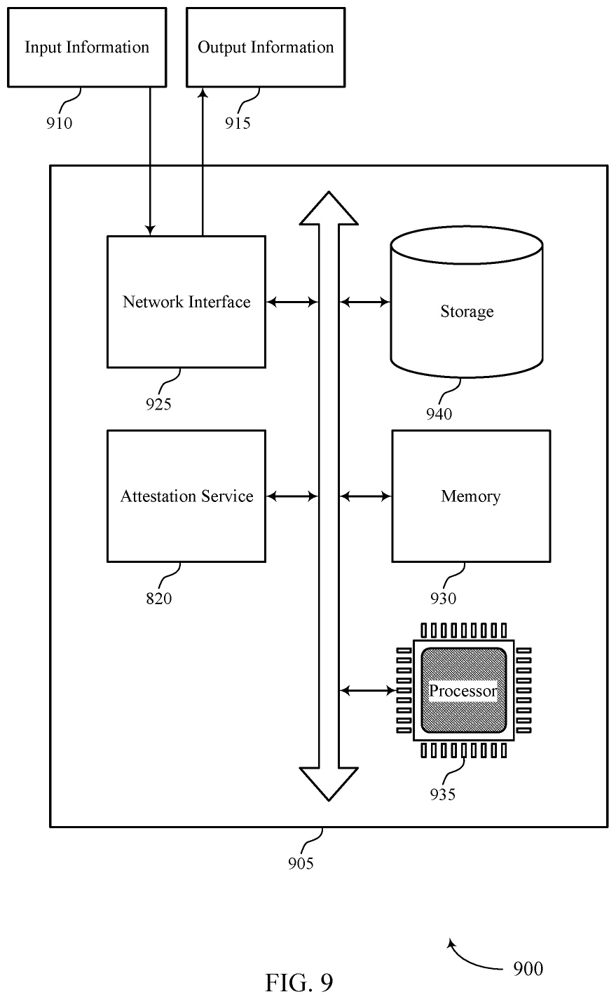

The input interface 710 may manage input signaling for the system 705. For example, the input interface 710 may receive input signaling (e.g., messages, packets, data, instructions, commands, transactions, or any other form of encoded information) from other systems or devices. The input interface 710 may send signaling corresponding to (e.g., representative of or otherwise based on) such input signaling to other components of the system 705 for processing. For example, the input interface 710 may transmit such corresponding signaling to the attestation service 720 to support on-chain attestations using user data. In some cases, the input interface 710 may be a component of a network interface 925 as described with reference to FIG. 9.

The output interface 715 may manage output signaling for the system 705. For example, the output interface 715 may receive signaling from other components of the system 705, such as the attestation service 720, and may transmit such output signaling corresponding to (e.g., representative of or otherwise based on) such signaling to other systems or devices. In some cases, the output interface 715 may be a component of a network interface 925 as described with reference to FIG. 9.

For example, the attestation service 720 may include a request receiver 725, an attribute verification component 730, an attestation record component 735, an identifier component 740, or any combination thereof. In some examples, the attestation service 720, or various components thereof, may be configured to perform various operations (e.g., receiving, monitoring, transmitting) using or otherwise in cooperation with the input interface 710, the output interface 715, or both. For example, the attestation service 720 may receive information from the input interface 710, send information to the output interface 715, or be integrated in combination with the input interface 710, the output interface 715, or both to receive information, transmit information, or perform various other operations as described herein.

The attestation service 720 may support data management in accordance with examples as disclosed herein. The request receiver 725 may be configured as or otherwise support a means for receiving, at a custodial token platform and from a client application on a user device, a request to generate an attestation record associated with a user profile of the custodial token platform. The attribute verification component 730 may be configured as or otherwise support a means for verifying, after receiving the request, that the user profile is associated with a set of attributes for the requested attestation record. The attestation record component 735 may be configured as or otherwise support a means for broadcasting, after verifying that the user profile is associated with the set of attributes, a first message that is configured to generate the attestation record via a blockchain network, wherein the first message is signed using a key associated with the custodial token platform. The identifier component 740 may be configured as or otherwise support a means for broadcasting a second message that is configured to store a mapping of an identifier for the attestation record and a self-custody blockchain address associated with the user profile.

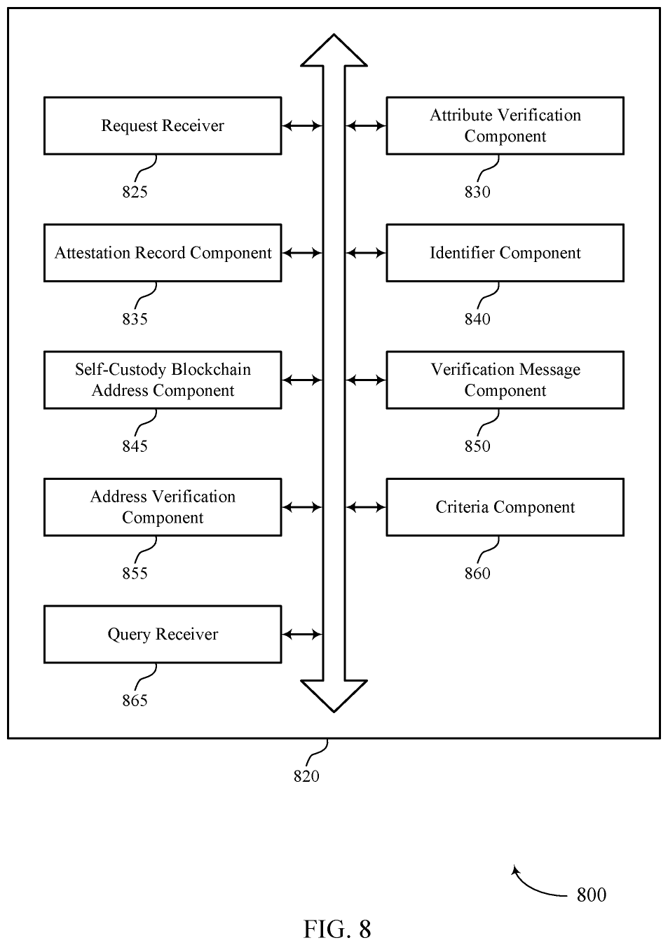

FIG. 8 shows a block diagram 800 of a attestation service 820 that supports on-chain attestations using user data in accordance with aspects of the present disclosure. The attestation service 820 may be an example of aspects of a attestation service or a attestation service 720, or both, as described herein. The attestation service 820, or various components thereof, may be an example of means for performing various aspects of on-chain attestations using user data as described herein. For example, the attestation service 820 may include a request receiver 825, an attribute verification component 830, an attestation record component 835, an identifier component 840, a self-custody blockchain address component 845, a verification message component 850, an address verification component 855, a criteria component 860, a query receiver 865, or any combination thereof. Each of these components may communicate, directly or indirectly, with one another (e.g., via one or more buses, communications links, communications interfaces, or any combination thereof).

The attestation service 820 may support data management in accordance with examples as disclosed herein. The request receiver 825 may be configured as or otherwise support a means for receiving, at a custodial token platform and from a client application on a user device, a request to generate an attestation record associated with a user profile of the custodial token platform. The attribute verification component 830 may be configured as or otherwise support a means for verifying, after receiving the request, that the user profile is associated with a set of attributes for the requested attestation record. The attestation record component 835 may be configured as or otherwise support a means for broadcasting, after verifying that the user profile is associated with the set of attributes, a first message that is configured to generate the attestation record via a blockchain network, wherein the first message is signed using a key associated with the custodial token platform. The identifier component 840 may be configured as or otherwise support a means for broadcasting a second message that is configured to store a mapping of an identifier for the attestation record and a self-custody blockchain address associated with the user profile.

In some examples, the request is associated with the self-custody blockchain address and wherein the first message is configured to associate the attestation record with the self-custody blockchain address on the blockchain network.

In some examples, the mapping further comprises an identifier for the custodial token platform, a schema identifier for the attestation record, or both.

In some examples, the self-custody blockchain address component 845 may be configured as or otherwise support a means for receiving, via the client application and prior to receiving the request to generate the attestation record, user input indicating the self-custody blockchain address. In some examples, the verification message component 850 may be configured as or otherwise support a means for generating, after receiving the request, a verification message to be signed via the self-custody blockchain address. In some examples, the address verification component 855 may be configured as or otherwise support a means for verifying that the verification message is signed by a private key associated with the self-custody blockchain address, wherein the user profile is verified after verifying that the verification message is signed by the key.

In some examples, to support verifying that the user profile is associated with the set of attributes, the attribute verification component 830 may be configured as or otherwise support a means for accessing a user record that is managed by the custodial token platform and that is associated with the user profile. In some examples, to support verifying that the user profile is associated with the set of attributes, the criteria component 860 may be configured as or otherwise support a means for determining whether data of the user record satisfies one or more criteria indicated by the set of attributes.

In some examples, the one or more criteria comprise a token balance, a geographic location, or both.

In some examples, the request receiver 825 may be configured as or otherwise support a means for receiving, at the custodial token platform via user input at the client application, a request to revoke the attestation record. In some examples, the attestation record component 835 may be configured as or otherwise support a means for broadcasting, after receiving the request to revoke the attestation record, a revocation message via the blockchain network, wherein the revocation message is configured to revoke the attestation record.

In some examples, the attribute verification component 830 may be configured as or otherwise support a means for determining, after broadcasting the first message that the user profile is not associated with the set of attributes. In some examples, the attestation record component 835 may be configured as or otherwise support a means for broadcasting, after determining that the user profile is not associated with the set of attributes, a revocation message via the blockchain network, wherein the revocation message is configured to revoke the attestation record.

In some examples, to support broadcasting the first message, the attestation record component 835 may be configured as or otherwise support a means for broadcasting the first message that is configured to call a schema, for the attestation record, that is stored in a self-executing program on the blockchain network, wherein the first message includes values that are to be included in fields defined by the schema.

In some examples, the query receiver 865 may be configured as or otherwise support a means for receiving, from a service external to the custodial token platform, a query indicating a criterion associated with the user profile. In some examples, the criteria component 860 may be configured as or otherwise support a means for transmitting, in response to the query, an indication of whether the criterion is satisfied by data of a user record associated with the user profile.

In some examples, the request receiver 825 may be configured as or otherwise support a means for verifying that the request is received from a service trusted by the custodial token platform, wherein the first message is broadcast based at least in part on verifying that the request is received from the service trusted by the custodial token platform.

In some examples, the request receiver 825 may be configured as or otherwise support a means for receiving, from a service trusted by the custodial token platform, a request to create a schema for the attestation record, wherein the client application is associated with the service and wherein the first message is broadcast and is configured to call the schema based at least in part on receiving the request from the client application that is associated with the service.

FIG. 9 shows a diagram of a system 900 including a system 905 that supports on-chain attestations using user data in accordance with aspects of the present disclosure. The system 905 may be an example of or include the components of a system 705 as described herein. The system 905 may include components for on-chain attestations using user data, such as a attestation service 920, an input information 910, an output information 915, a network interface 925, at least one memory 930, at least one processor 935, and a storage 940. Each of these components may communicate, directly or indirectly, with one another (e.g., via one or more buses, communications links, communications interfaces, or any combination thereof).

The network interface 925 may enable the system 905 to exchange information (e.g., input information 910, output information 915, or both) with other systems or devices (not shown). For example, the network interface 925 may enable the system 905 to connect to a network (e.g., a network 135 as described herein). The network interface 925 may include one or more wireless network interfaces, one or more wired network interfaces, or any combination thereof.

Memory 930 may include RAM, ROM, or both. The memory 930 may store computer-readable, computer-executable software including instructions that, when executed, cause at least one processor 935 to perform various functions described herein, such as functions supporting on-chain attestations using user data. In some cases, the memory 930 may contain, among other things, a basic input/output system (BIOS), which may control basic hardware or software operation such as the interaction with peripheral components or devices. In some cases, the memory 930 may be an example of aspects of one or more components of a custodial token platform 110 as described with reference to FIG. 1. The memory 930 may be an example of a single memory or multiple memories. For example, the system 905 may include one or more memories 930.

The processor 935 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 935 may be configured to execute computer-readable instructions stored in at least one memory 930 to perform various functions (e.g., functions or tasks supporting on-chain attestations using user data). Though a single processor 935 is depicted in the example of FIG. 9, it is to be understood that the system 905 may include any quantity of one or more of processors 935 and that a group of processors 935 may collectively perform one or more functions ascribed herein to a processor, such as the processor 935. The processor 935 may be an example of a single processor or multiple processors. For example, the system 905 may include one or more processors 935.

Storage 940 may be configured to store data that is generated, processed, stored, or otherwise used by the system 905. In some cases, the storage 940 may include one or more HDDs, one or more SDDs, or both. In some examples, the storage 940 may be an example of a single database, a distributed database, multiple distributed databases, a data store, a data lake, or an emergency backup database. In some examples, the storage 940 may be an example of one or more components described with reference to FIG. 1.

The attestation service 920 may support data management in accordance with examples as disclosed herein. For example, the attestation service 920 may be configured as or otherwise support a means for receiving, at a custodial token platform and from a client application on a user device, a request to generate an attestation record associated with a user profile of the custodial token platform. The attestation service 920 may be configured as or otherwise support a means for verifying, after receiving the request, that the user profile is associated with a set of attributes for the requested attestation record. The attestation service 920 may be configured as or otherwise support a means for broadcasting, after verifying that the user profile is associated with the set of attributes, a first message that is configured to generate the attestation record via a blockchain network, wherein the first message is signed using a key associated with the custodial token platform. The attestation service 920 may be configured as or otherwise support a means for broadcasting a second message that is configured to store a mapping of an identifier for the attestation record and a self-custody blockchain address associated with the user profile.

By including or configuring the attestation service 920 in accordance with examples as described herein, the system 905 may support techniques for improved user experience related to accessibility of attestations.

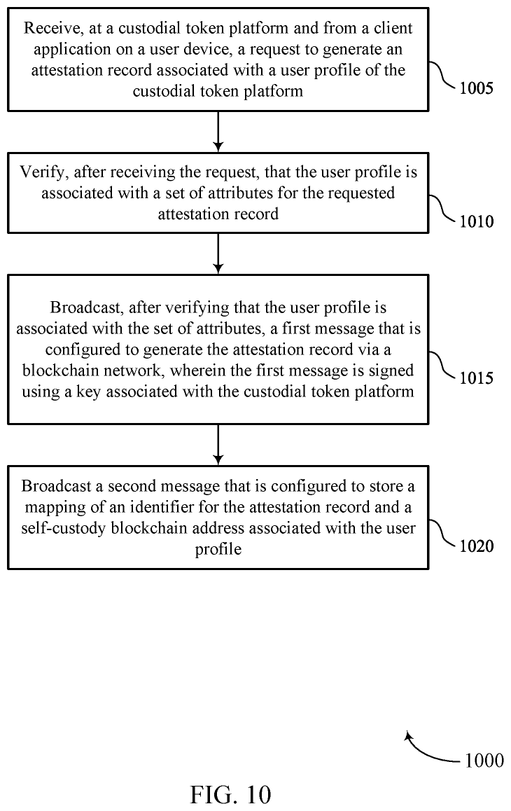

FIG. 10 shows a flowchart illustrating a method 1000 that supports on-chain attestations using user data in accordance with aspects of the present disclosure. The operations of the method 1000 may be implemented by a custodial token platform or its components as described herein. For example, the operations of the method 1000 may be performed by a custodial token platform as described with reference to FIGS. 1 through 9. In some examples, a custodial token platform may execute a set of instructions to control the functional elements of the custodial token platform to perform the described functions. Additionally, or alternatively, the custodial token platform may perform aspects of the described functions using special-purpose hardware.

At 1005, the method may include receiving, at a custodial token platform and from a client application on a user device, a request to generate an attestation record associated with a user profile of the custodial token platform. The operations of block 1005 may be performed in accordance with examples as disclosed herein. In some examples, aspects of the operations of 1005 may be performed by a request receiver 825 as described with reference to FIG. 8.

At 1010, the method may include verifying, after receiving the request, that the user profile is associated with a set of attributes for the requested attestation record. The operations of block 1010 may be performed in accordance with examples as disclosed herein. In some examples, aspects of the operations of 1010 may be performed by an attribute verification component 830 as described with reference to FIG. 8.

At 1015, the method may include broadcasting, after verifying that the user profile is associated with the set of attributes, a first message that is configured to generate the attestation record via a blockchain network, wherein the first message is signed using a key associated with the custodial token platform. The operations of block 1015 may be performed in accordance with examples as disclosed herein. In some examples, aspects of the operations of 1015 may be performed by an attestation record component 835 as described with reference to FIG. 8.

At 1020, the method may include broadcasting a second message that is configured to store a mapping of an identifier for the attestation record and a self-custody blockchain address associated with the user profile. The operations of block 1020 may be performed in accordance with examples as disclosed herein. In some examples, aspects of the operations of 1020 may be performed by an identifier component 840 as described with reference to FIG. 8.

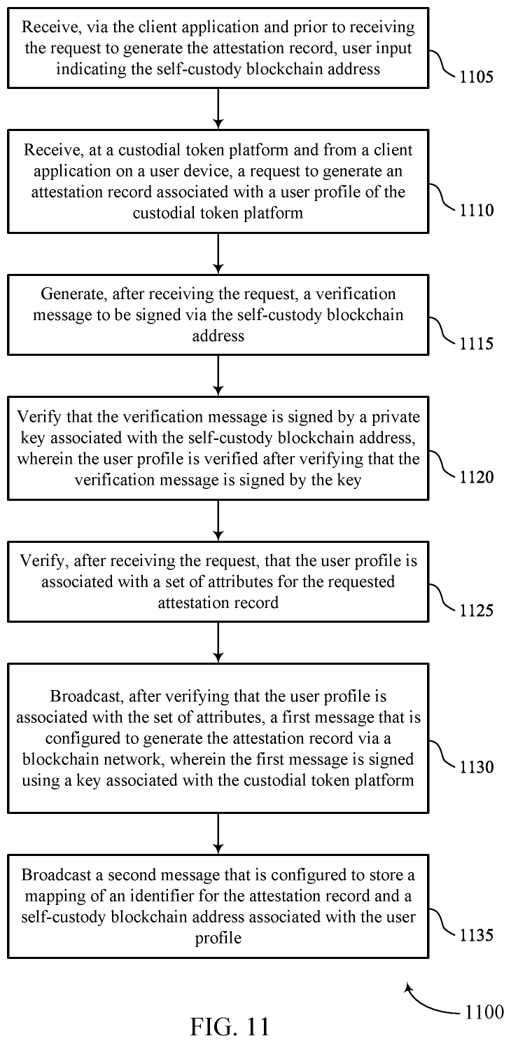

FIG. 11 shows a flowchart illustrating a method 1100 that supports on-chain attestations using user data in accordance with aspects of the present disclosure. The operations of the method 1100 may be implemented by a custodial token platform or its components as described herein. For example, the operations of the method 1100 may be performed by a custodial token platform as described with reference to FIGS. 1 through 9. In some examples, a custodial token platform may execute a set of instructions to control the functional elements of the custodial token platform to perform the described functions. Additionally, or alternatively, the custodial token platform may perform aspects of the described functions using special-purpose hardware.

At 1105, the method may include receiving, via the client application and prior to receiving the request to generate the attestation record, user input indicating the self-custody blockchain address. The operations of block 1105 may be performed in accordance with examples as disclosed herein. In some examples, aspects of the operations of 1105 may be performed by a self-custody blockchain address component 845 as described with reference to FIG. 8.

At 1110, the method may include receiving, at a custodial token platform and from a client application on a user device, a request to generate an attestation record associated with a user profile of the custodial token platform. The operations of block 1110 may be performed in accordance with examples as disclosed herein. In some examples, aspects of the operations of 1110 may be performed by a request receiver 825 as described with reference to FIG. 8.

At 1115, the method may include generating, after receiving the request, a verification message to be signed via the self-custody blockchain address. The operations of block 1115 may be performed in accordance with examples as disclosed herein. In some examples, aspects of the operations of 1115 may be performed by a verification message component 850 as described with reference to FIG. 8.

At 1120, the method may include verifying that the verification message is signed by a private key associated with the self-custody blockchain address, wherein the user profile is verified after verifying that the verification message is signed by the key. The operations of block 1120 may be performed in accordance with examples as disclosed herein. In some examples, aspects of the operations of 1120 may be performed by an address verification component 855 as described with reference to FIG. 8.

At 1125, the method may include verifying, after receiving the request, that the user profile is associated with a set of attributes for the requested attestation record. The operations of block 1125 may be performed in accordance with examples as disclosed herein. In some examples, aspects of the operations of 1125 may be performed by an attribute verification component 830 as described with reference to FIG. 8.

At 1130, the method may include broadcasting, after verifying that the user profile is associated with the set of attributes, a first message that is configured to generate the attestation record via a blockchain network, wherein the first message is signed using a key associated with the custodial token platform. The operations of block 1130 may be performed in accordance with examples as disclosed herein. In some examples, aspects of the operations of 1130 may be performed by an attestation record component 835 as described with reference to FIG. 8.

At 1135, the method may include broadcasting a second message that is configured to store a mapping of an identifier for the attestation record and a self-custody blockchain address associated with the user profile. The operations of block 1135 may be performed in accordance with examples as disclosed herein. In some examples, aspects of the operations of 1135 may be performed by an identifier component 840 as described with reference to FIG. 8.

A method for data management by an apparatus is described. The method may include receiving, at a custodial token platform and from a client application on a user device, a request to generate an attestation record associated with a user profile of the custodial token platform, verifying, after receiving the request, that the user profile is associated with a set of attributes for the requested attestation record, broadcasting, after verifying that the user profile is associated with the set of attributes, a first message that is configured to generate the attestation record via a blockchain network, wherein the first message is signed using a key associated with the custodial token platform, and broadcasting a second message that is configured to store a mapping of an identifier for the attestation record and a self-custody blockchain address associated with the user profile.

An apparatus for data management is described. The apparatus may include one or more memories storing processor executable code, and one or more processors coupled with the one or more memories. The one or more processors may individually or collectively operable to execute the code to cause the apparatus to receive, at a custodial token platform and from a client application on a user device, a request to generate an attestation record associated with a user profile of the custodial token platform, verifying, after receiving the request, that the user profile is associated with a set of attributes for the requested attestation record, broadcast, after verifying that the user profile is associated with the set of attributes, a first message that is configured to generate the attestation record via a blockchain network, wherein the first message is signed using a key associated with the custodial token platform, and broadcast a second message that is configured to store a mapping of an identifier for the attestation record and a self-custody blockchain address associated with the user profile.

Another apparatus for data management is described. The apparatus may include means for receiving, at a custodial token platform and from a client application on a user device, a request to generate an attestation record associated with a user profile of the custodial token platform, means for verifying, after receiving the request, that the user profile is associated with a set of attributes for the requested attestation record, means for broadcasting, after verifying that the user profile is associated with the set of attributes, a first message that is configured to generate the attestation record via a blockchain network, wherein the first message is signed using a key associated with the custodial token platform, and means for broadcasting a second message that is configured to store a mapping of an identifier for the attestation record and a self-custody blockchain address associated with the user profile.

A non-transitory computer-readable medium storing code for data management is described. The code may include instructions executable by a processor to receive, at a custodial token platform and from a client application on a user device, a request to generate an attestation record associated with a user profile of the custodial token platform, verifying, after receiving the request, that the user profile is associated with a set of attributes for the requested attestation record, broadcast, after verifying that the user profile is associated with the set of attributes, a first message that is configured to generate the attestation record via a blockchain network, wherein the first message is signed using a key associated with the custodial token platform, and broadcast a second message that is configured to store a mapping of an identifier for the attestation record and a self-custody blockchain address associated with the user profile.

In some examples of the method, apparatus, and non-transitory computer-readable medium described herein, the request may be associated with the self-custody blockchain address and wherein the first message may be configured to associate the attestation record with the self-custody blockchain address on the blockchain network.

In some examples of the method, apparatus, and non-transitory computer-readable medium described herein, the mapping further comprises an identifier for the custodial token platform, a schema identifier for the attestation record, or both.

Some examples of the method, apparatus, and non-transitory computer-readable medium described herein may further include operations, features, means, or instructions for receiving, via the client application and prior to receiving the request to generate the attestation record, user input indicating the self-custody blockchain address, generating, after receiving the request, a verification message to be signed via the self-custody blockchain address, and verifying that the verification message may be signed by a private key associated with the self-custody blockchain address, wherein the user profile may be verified after verifying that the verification message may be signed by the key.

In some examples of the method, apparatus, and non-transitory computer-readable medium described herein, verifying that the user profile may be associated with the set of attributes may include operations, features, means, or instructions for accessing a user record that may be managed by the custodial token platform and that may be associated with the user profile and determining whether data of the user record satisfies one or more criteria indicated by the set of attributes.

In some examples of the method, apparatus, and non-transitory computer-readable medium described herein, the one or more criteria comprise a token balance, a geographic location, or both.

Some examples of the method, apparatus, and non-transitory computer-readable medium described herein may further include operations, features, means, or instructions for receiving, at the custodial token platform via user input at the client application, a request to revoke the attestation record and broadcasting, after receiving the request to revoke the attestation record, a revocation message via the blockchain network, wherein the revocation message may be configured to revoke the attestation record.

Some examples of the method, apparatus, and non-transitory computer-readable medium described herein may further include operations, features, means, or instructions for determining, after broadcasting the first message that the user profile may be not associated with the set of attributes and broadcasting, after determining that the user profile may be not associated with the set of attributes, a revocation message via the blockchain network, wherein the revocation message may be configured to revoke the attestation record.

In some examples of the method, apparatus, and non-transitory computer-readable medium described herein, broadcasting the first message may include operations, features, means, or instructions for broadcasting the first message that may be configured to call a schema, for the attestation record, that may be stored in a self-executing program on the blockchain network, wherein the first message includes values that may be included in fields defined by the schema.

Some examples of the method, apparatus, and non-transitory computer-readable medium described herein may further include operations, features, means, or instructions for receiving, from a service external to the custodial token platform, a query indicating a criterion associated with the user profile and transmitting, in response to the query, an indication of whether the criterion may be satisfied by data of a user record associated with the user profile.

Some examples of the method, apparatus, and non-transitory computer-readable medium described herein may further include operations, features, means, or instructions for verifying that the request may be received from a service trusted by the custodial token platform, wherein the first message may be broadcast based at least in part on verifying that the request may be received from the service trusted by the custodial token platform.

Some examples of the method, apparatus, and non-transitory computer-readable medium described herein may further include operations, features, means, or instructions for receiving, from a service trusted by the custodial token platform, a request to create a schema for the attestation record, wherein the client application may be associated with the service and wherein the first message may be broadcast and may be configured to call the schema based at least in part on receiving the request from the client application that may be associated with the service.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data management, comprising:
receiving, at a custodial token platform and from a client application on a user device, a request to generate an attestation record associated with a user profile of the custodial token platform;
verifying, after receiving the request, that the user profile is associated with a set of attributes for the requested attestation record;
broadcasting, after verifying that the user profile is associated with the set of attributes, a first message that is configured to generate the attestation record via a blockchain network, wherein the first message is signed using a key associated with the custodial token platform; and
broadcasting a second message that is configured to store a mapping of an identifier for the attestation record and a self-custody blockchain address associated with the user profile.

2. The method of claim 1, wherein the request is associated with the self-custody blockchain address and wherein the first message is configured to associate the attestation record with the self-custody blockchain address on the blockchain network.

3. The method of claim 1, wherein the mapping further comprises an identifier for the custodial token platform, a schema identifier for the attestation record, or both.

4. The method of claim 1, further comprising:
receiving, via the client application and prior to receiving the request to generate the attestation record, user input indicating the self-custody blockchain address;
generating, after receiving the request, a verification message to be signed via the self-custody blockchain address; and
verifying that the verification message is signed by a private key associated with the self-custody blockchain address, wherein the user profile is verified after verifying that the verification message is signed by the key.

5. The method of claim 1, wherein verifying that the user profile is associated with the set of attributes comprises:
accessing a user record that is managed by the custodial token platform and that is associated with the user profile; and
determining whether data of the user record satisfies one or more criteria indicated by the set of attributes.

6. The method of claim 5, wherein the one or more criteria comprise a token balance, a geographic location, a know-your-customer status, an identity, or any combination thereof.

7. The method of claim 1 wherein verifying that the user profile is associated with the set of attributes comprises:
obtaining information associated with the user profile from an external data source; and
determining whether the information associated with the user profile satisfies one or more criteria indicated by the set of attributes.

8. The method of claim 1, further comprising:
receiving, at the custodial token platform via user input at the client application, a request to revoke the attestation record; and
broadcasting, after receiving the request to revoke the attestation record, a revocation message via the blockchain network, wherein the revocation message is configured to revoke the attestation record.

9. The method of claim 1, further comprising:
determining, after broadcasting the first message that the user profile is not associated with the set of attributes; and
broadcasting, after determining that the user profile is not associated with the set of attributes, a revocation message via the blockchain network, wherein the revocation message is configured to revoke the attestation record.

10. The method of claim 1, wherein broadcasting the first message comprises:
broadcasting the first message that is configured to call a schema, for the attestation record, that is stored in a self-executing program on the blockchain network, wherein the first message includes values that are to be included in fields defined by the schema.

11. The method of claim 1, further comprising:
receiving, from a service external to the custodial token platform, a query indicating a criterion associated with the user profile; and
transmitting, in response to the query, an indication of whether the criterion is satisfied by data of a user record associated with the user profile.

12. The method of claim 1, further comprising:
verifying that the request is received from a service trusted by the custodial token platform, wherein the first message is broadcast based at least in part on verifying that the request is received from the service trusted by the custodial token platform.

13. The method of claim 1, further comprising:
receiving, from a service external to the custodial token platform, a query indicating the self-custody blockchain address;
reading, from a smart contract that stores the mapping, the identifier for the attestation record; and
transmitting, in response to the query, an indication of the identifier for the attestation record.

14. The method of claim 1, further comprising:
receiving, from a service trusted by the custodial token platform, a request to create a schema for the attestation record, wherein the client application is associated with the service and wherein the first message is broadcast and is configured to call the schema based at least in part on receiving the request from the client application that is associated with the service.

15. An apparatus for data management, comprising:
one or more memories storing processor-executable code; and
one or more processors coupled with the one or more memories and individually or collectively operable to execute the code to cause the apparatus to:
receive, at a custodial token platform and from a client application on a user device, a request to generate an attestation record associated with a user profile of the custodial token platform;
verify, after receiving the request, that the user profile is associated with a set of attributes for the requested attestation record;
broadcast, after verifying that the user profile is associated with the set of attributes, a first message that is configured to generate the attestation record via a blockchain network, wherein the first message is signed using a key associated with the custodial token platform; and
broadcast a second message that is configured to store a mapping of an identifier for the attestation record and a self-custody blockchain address associated with the user profile.

16. The apparatus of claim 15, wherein the request is associated with the self-custody blockchain address and wherein the first message is configured to associate the attestation record with the self-custody blockchain address on the blockchain network.

17. The apparatus of claim 15, wherein the mapping further comprises an identifier for the custodial token platform, a schema identifier for the attestation record, or both.

18. The apparatus of claim 15, wherein the one or more processors are individually or collectively further operable to execute the code to cause the apparatus to:
receive, via the client application and prior to receiving the request to generate the attestation record, user input indicating the self-custody blockchain address;
generate, after receiving the request, a verification message to be signed via the self-custody blockchain address; and
verify that the verification message is signed by a private key associated with the self-custody blockchain address, wherein the user profile is verified after verifying that the verification message is signed by the key.

19. A non-transitory computer-readable medium storing code for data management, the code comprising instructions executable by one or more processors to:
receive, at a custodial token platform and from a client application on a user device, a request to generate an attestation record associated with a user profile of the custodial token platform;
verify, after receiving the request, that the user profile is associated with a set of attributes for the requested attestation record;
broadcast, after verifying that the user profile is associated with the set of attributes, a first message that is configured to generate the attestation record via a blockchain network, wherein the first message is signed using a key associated with the custodial token platform; and
broadcast a second message that is configured to store a mapping of an identifier for the attestation record and a self-custody blockchain address associated with the user profile.

20. The non-transitory computer-readable medium of claim 19, wherein the instructions are further executable by the one or more processors to:
receive, at the custodial token platform via user input at the client application, a request to revoke the attestation record; and
broadcast, after receiving the request to revoke the attestation record, a revocation message via the blockchain network, wherein the revocation message is configured to revoke the attestation record.
